(19) United States
(12) Patent Application Publication
(10) Pub. No.: US 2026/0249626 A1
(43) Pub. Date: Aug. 27, 2026

(54) RECORDING APPARATUS

(71) Applicant: BROTHER KOGYO KABUSHIKI KAISHA, Nagoya (JP)

(72) Inventors: Ryosuke SAKAI, Nagoya (JP); Yuwen WANG, Nagoya (JP); Kazuaki OOKA, Nagoya (JP)

(21) Appl. No.: 19/644,722

(22) Filed: Apr. 10, 2026

Related U.S. Application Data
(63) Continuation of application No. PCT/JP2024/037168, filed on Oct. 18, 2024.

(30) Foreign Application Priority Data
Oct. 31, 2023 (JP) 2023-187188

(51) Int. Cl. B41J 11/70; B41J 3/407; B41J 11/66; B41J 15/04

(52) U.S. Cl. CPC B41J 11/703; B41J 3/4075; B41J 11/663; B41J 15/044; B41J 15/046

(57) ABSTRACT

A recording apparatus includes: a main body having an opening; a cover; first and second holders; a conveyance route; a recording part; a bonding part; and a cutting part. The first holder is configured to hold a first cartridge holding a first roll in which a first sheet is wound. The second holder is configured to hold a second cartridge holding a second roll in which a second sheet is wound. The recording part is configured to record an image on the first sheet. The bonding part is configured to bond the first sheet and the second sheet together. The cutting part is configured to cut the first sheet. A particular cartridge being the first cartridge or the second cartridge is mountable to the main body through the opening of the main body. The particular cartridge mounted to the main body is located above the cutting part.

### REFERENCE TO RELATED APPLICATIONS

This application is a Continuation Application of International Application No. PCT/JP2024/037168 filed on October 18, 2024, that claims the conventional priority of Japanese patent Application No. 2023-187188 filed on October 31, 2023. The entire content of Japanese patent Application No. 2023-187188 and the entire content of International Application No. PCT/JP2024/037168 are incorporated herein by reference.

### BACKGROUND ART

A printing apparatus configured to produce a laminated label by using an ink ribbon, a printing tape, and a transparent tape has been known. In some of such printing apparatuses, a printing tape, a transparent tape, and an ink ribbon are accommodated in a tape cassette. The tape cassette is mounted to a cassette accommodating part of a printing apparatus. The printing apparatus includes a thermal head. The thermal head heats an ink layer of the ink ribbon to transfer an image onto the printing tape. A laminated label is produced by bonding the transparent tape and the printing tape with printed image together.

### SUMMARY

Regarding laminated labels, increasing of a combination of a printing tape and a transparent tape, increasing of a tape volume, capability of changing of printing color are desired, for example. However, in the above printing apparatus, since the printing tape, the transparent tape, and the ink ribbon are accommodated in the single tape cassette, combinations of a printing tape and a transparent tape which can be used by a user is limited to specific combinations selected by a manufacturer.

Furthermore, in the above printing apparatus, a cutter unit is replaced together with the tape cassette. A configuration in which a printing tape and a transparent tape can be mounted to an apparatus independently from each other, and a cutter unit can be replaced after consumption is desired.

The present disclosure has been made in view of the above circumstances, and an object of the present disclosure is to provide a recording apparatus in which a combination of a first sheet and a second sheet to be bonded together is selectable and in which access to a cutting part is easy.

An aspect of a recording apparatus according to the present disclosure includes a main body having an opening defined at an upper end of the main body; a cover; first and second holders; a conveyance route; a recording part; a bonding part located downstream of the recording part, in a conveyance direction of the conveyance route; and a cutting part located upstream in the conveyance direction of the bonding part and downstream in the conveyance direction of the recording part. The cover is configured to open and close the opening of the main body. The first holder is configured to hold a first cartridge mounted to the main body, the first cartridge holding a first roll in which a first sheet is wound. The second holder is configured to hold a second cartridge mounted to the main body, the second cartridge holding a second roll in which a second sheet is wound. The conveyance route is configured such that the first sheet travels through the conveyance route in the conveyance direction. The recording part is configured to record an image on the first sheet travelling through the conveyance route. The bonding part is configured to bond the first sheet and the second sheet together. The cutting part is configured to cut the first sheet. A particular cartridge being the first cartridge or the second cartridge is mountable to the main body through the opening of the main body. The particular cartridge mounted to the main body is located above the cutting part.

The particular cartridge being the first cartridge or the second cartridge, and the cutting part can be replaced independently from each other through the opening of the main body. Furthermore, in a case where the particular cartridge is removed from the main body, the cutting part is located at a position facing the opening. Therefore, a user can easily access the cutting part through the opening of the main body and perform replacement work at the cutting part.

According to the present disclosure, the recording apparatus in which the combination of the first sheet and the second sheet to be bonded together is selectable and in which access to the cutting part in performing replacement of the cutting part is easy can be realized.

### BRIEF DESCRIPTION OF DRAWINGS

FIG. 1A is an exterior perspective view of a laminating apparatus 1, and FIG. 1B is a schematic cross-sectional view of a laminated product 100 produced by the laminating apparatus 1.

FIG. 2 is an exterior perspective view illustrating the laminating apparatus 1 in a state that a cover 12 is opened.

FIG. 3 is a longitudinal sectional view of the laminating apparatus 1.

FIG. 4 is a longitudinal sectional view of the laminating apparatus 1 as viewed from an opposite side in a left-right direction of FIG. 3.

FIG. 5 is a longitudinal sectional view of a first cartridge 114.

FIG. 6 is a schematic view illustrating a portion of a cross-section, in the left-right direction, of the first cartridge 114.

FIG. 7 is a longitudinal sectional view of a second cartridge 124.

FIG. 8 is a schematic view illustrating a portion of a cross-section, in the left-right direction, of the second cartridge 124.

FIG. 9 is a longitudinal sectional view of the laminating apparatus 1 in a state that the first cartridge 114 and the second cartridge 124 are removed from the laminating apparatus 1.

FIG. 10 is a perspective view illustrating a left frame 77, a right frame 78, and a first cutting part 61.

FIG. 11 is a perspective view illustrating the first cutting part 61.

FIG. 12A is a perspective view illustrating a cutter carriage 82 in which a lever 85 is located at a first position, and FIG. 12B is a perspective view illustrating the cutter carriage 82 in which the lever 85 is located at a second position.

FIG. 13 is a perspective view illustrating the cutter unit 83.

FIG. 14 is a schematic view illustrating a guide 93.

FIG. 15 is a block diagram illustrating the controller 200.

FIG. 16 is a flowchart.

### DESCRIPTION

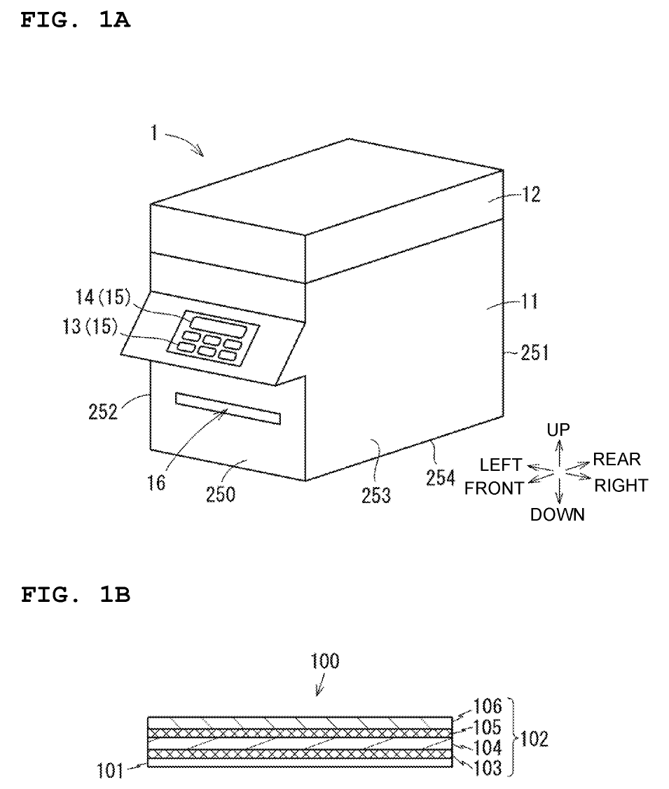

In the following, a laminating apparatus 1 according to an embodiment of a present disclosure will be described. It should be understood that the embodiment described below is merely an example of the present disclosure, and it goes without saying that the embodiment of the present disclosure may be appropriately modified within a scope that does not alter a gist of the present disclosure. In the following description, an upward direction and a downward direction are defined based on a state in which the laminating apparatus 1 is installed usably, as illustrated in FIG. 1A. Furthermore, a front direction and a rear direction are defined such that a front surface of the laminating apparatus 1 in a state that the laminating apparatus 1 is installed usably as illustrated in FIG. 1A is defined as the front surface. A left direction and a right direction are defined viewing the laminating apparatus 1 from the front. Note that, in the embodiment described below, the upward direction and the downward direction may collectively be referred to as an up-down direction, the front direction and the rear direction may collectively be referred to as a front-rear direction, and the left direction and the right direction may collectively be referred to as a left-right direction. The up-down direction, the front-rear direction, and the left-right direction are orthogonal to one another. The up-down direction is parallel to a direction of gravity. The front-rear direction and the left-right direction are parallel to a horizontal direction. The up-down direction is an example of a first direction. The left-right direction is an example of a second direction. The right side in the left-right direction is an example of a first end side. The left side in the left-right direction is an example of a second end side.

### Outline of Laminating Apparatus 1

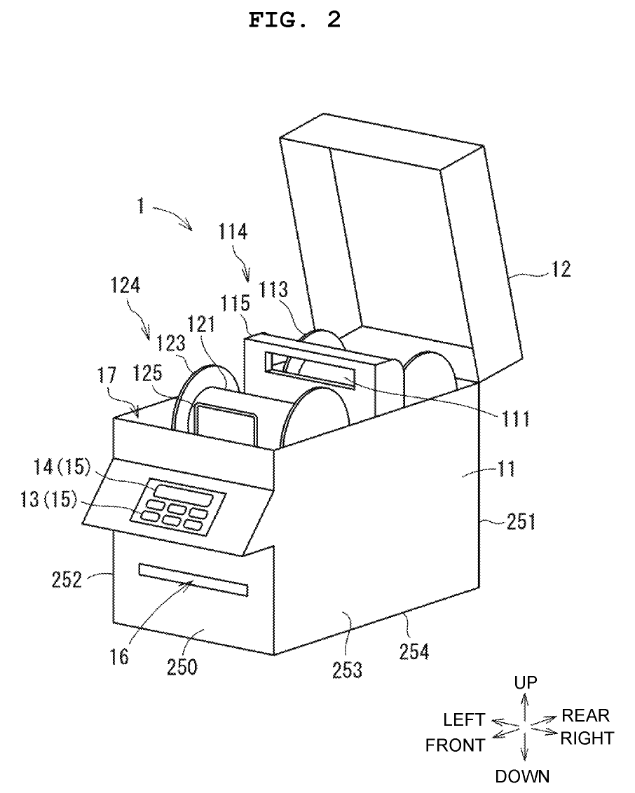

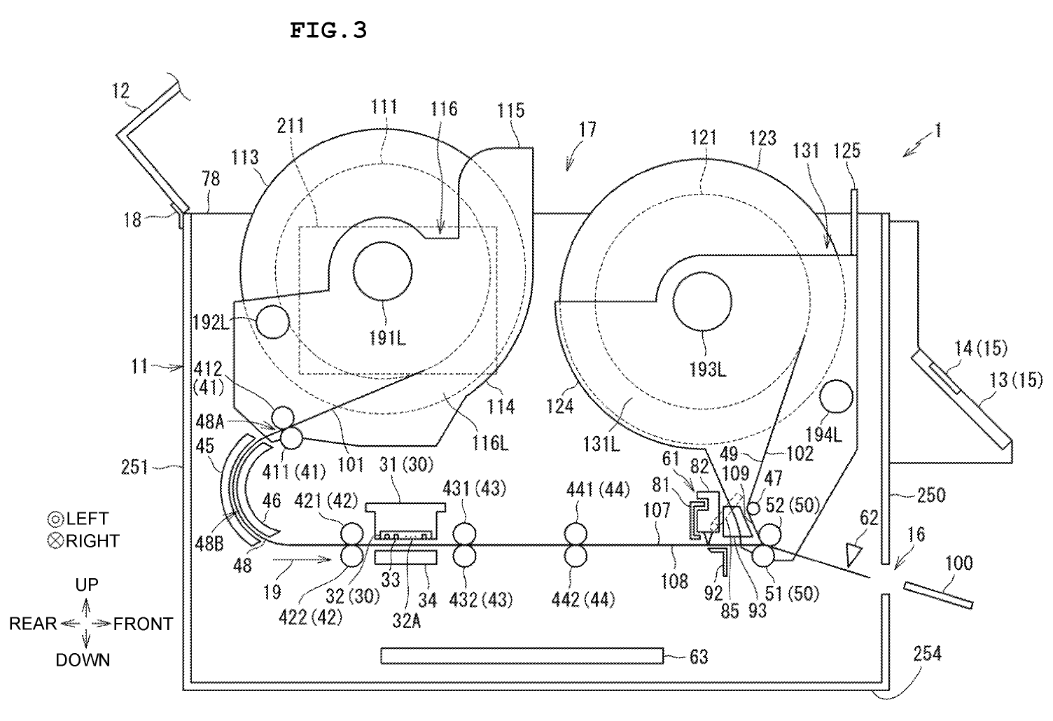

As illustrated in FIG. 1A, the laminating apparatus 1 is an apparatus having a substantially rectangular parallelepiped appearance. The laminating apparatus 1 is an example of a recording apparatus. The laminating apparatus 1 has an internal space. The laminating apparatus 1 includes a main body 11, and a cover 12 covering an upper portion of the main body 11. The main body 11 has a front wall 250, a rear wall 251 opposite the front wall 250, a left wall 252 and a right wall 253 extending between the front wall 250 and the rear wall 251, and a bottom wall 254. The main body 11 defines the internal space of the laminating apparatus 1 with the front wall 250, the rear wall 251, the left wall 252, the right wall 253, and the bottom wall 254. Furthermore, as illustrated in FIG. 2, the main body 11 has an opening 17 at an upper end of the main body 11. The cover 12 is located above the main body 11. As illustrated in FIG. 3, the rear wall 251 of the main body 11 and the rear wall 251 of the cover 12 are connected with a hinge 18. The cover 12 defines an upper end of the internal space of the laminating apparatus 1. A combination of the main body 11 and the cover 12 is an example of a housing.

The laminating apparatus 1 has an operation panel 15 disposed on the front wall 250. The operation panel 15 includes an operation part 13 configured to accept an operation by a user and a display part 14 configured to notify a user of various kinds of information. The laminating apparatus 1 includes a controller and various motors. The controller controls an operation of each part of the laminating apparatus 1.

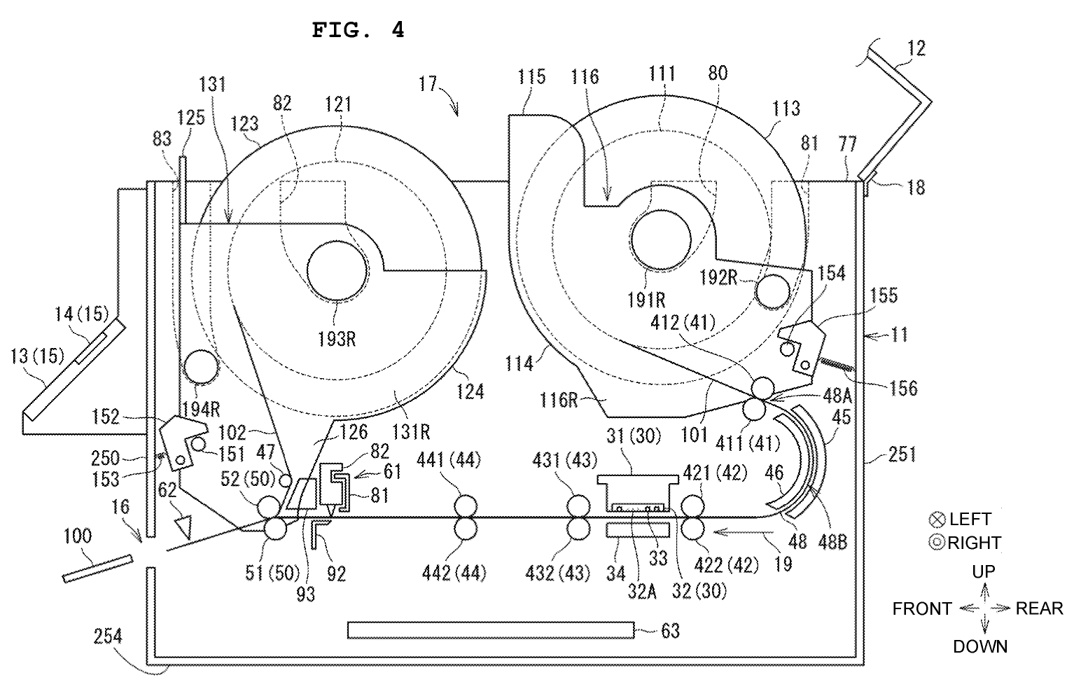

The cover 12 is movable to a position where the cover 12 closes the opening 17 and a position where the cover 12 opens the opening 17. The cover 12 is opened and closed by a user operation. FIG. 1A illustrates a state in which the cover 12 closes the opening 17. FIG. 2 illustrates a state in which the cover 12 opens the opening 17. The main body 11 and the cover 12 define the internal space of the laminating apparatus 1. An internal space of the main body 11 can be accessed from an outside through the opening 17. Furthermore, as illustrated in FIG. 3 and FIG. 4, the laminating apparatus 1 includes, in the internal space, a first cartridge 114 configured to accommodate a first roll 111 constructed by a first sheet 101, a second cartridge 124 configured to accommodate a second roll 121 constructed by a second sheet 102; a recording part 30; first conveyance rollers 41 to fourth conveyance rollers 44, a bonding part 50, a first cutting part 61, and a second cutting part 62. The laminating apparatus 1 includes a left frame 77 and a right frame 78 that support the recording part 30, the first conveyance rollers 41 to the fourth conveyance rollers 44, the bonding part 50, the first cutting part 61, and the second cutting part 62 in the internal space. In a state that the cover 12 is opened in the internal space, a user can replace the first roll 111 and the second roll 121 independently from each other through the opening 17 of the laminating apparatus 1.

The main body 11 has a discharge port 16. The discharge port 16 is disposed on the front wall 250 of the main body 11 at a position below the operation part 13 and the display part 14. A laminated product 100, produced by bonding the first sheet 101 and the second sheet 102 together in the internal space of the laminating apparatus 1, is discharged to an outside through the discharge port 16.

As illustrated in FIG. 2 to FIG. 5, the first roll 111 includes a first shaft 112 having a cylindrical shape with flanges 113 and a first sheet 101 wound around the first shaft 112. The first roll 111 is configured to be mounted to the laminating apparatus 1 in a state that the first roll is accommodated in the first cartridge 114. The second roll 121 includes a second shaft 122 having a cylindrical shape with flanges 123, and a second sheet 102 wound around the second shaft 122. The second roll 121 is configured to be mounted to the laminating apparatus 1 in a state that the second roll 121 is accommodated in a second cartridge 124.

The first sheet 101 is, for example, a transparent film. As illustrated in FIG. 1B, the second sheet 102 is a member having adhesive layer(s) 103, 105 on at least one surface. The second sheet 102 has, for example, a first adhesive layer 103 on one surface of the tape layer 104 and a second adhesive layer 105 on the other surface of a tape layer 104. The first adhesive layer 103 faces radially inward on the second roll 121. The one surface of the tape layer 104 is a surface facing the first sheet 101 in the laminated product 100. A release sheet 106 is located on an opposite side of the tape layer 104 relative to the second adhesive layer 105.

A material of the first sheet 101 and a material of the second sheet 102 may be any material. The second sheet 102 may be, for example, a resin member such as PET, PVC (polyvinyl chloride), a synthetic paper such as YUPO ("YUPO" is registered trademark of YUPO CORPORATION), or a metal member. The second sheet 102 may be transparent or opaque. The first sheet 101 and the second sheet 102 may have an adhesive layer on one surface, on the other surface, on both surfaces, or on neither surface. In a case where materials without an adhesive layer is used, the first sheet 101 and the second sheet 102 may be bonded together after an adhesive is applied, or may be bonded together by, for example, heat sealing or pressure bonding.

As illustrated in FIG. 3, a recording surface 107 is a surface of the first sheet 101 on which an image is to be recorded. A back surface 108 is a surface of the first sheet 101 opposite the recording surface 107. A bonding surface 109 is a surface of the second sheet 102 having the first adhesive layer 103.

As illustrated in FIG. 3 and FIG. 4, the left frame 77 and the right frame 78 are disposed in the internal space of the main body 11 apart from each other in the left-right direction. In other words, in the left-right direction, the recording part 30, the first conveyance rollers 41 to the fourth conveyance rollers 44, the bonding part 50, the first cutting part 61, and the second cutting part 62 are located between the left frame 77 and the right frame 78. The left frame 77 and right frame 78 are, for example, flat plates made of steel.

The first conveyance route 48 is a conveyance route through which the first sheet 101 passes. The first conveyance route 48 and the second conveyance route 49 are conveyance routes through which the first sheet 101 and the second sheet 102 pass. The first conveyance route 48 and the second conveyance route 49 are defined by unillustrated guide members and unillustrated rollers. The first conveyance route 48 has a curved section 48B being curved. The curved section 48B is a route defined by guide surfaces of guide members 45, 46. The first sheet 101 unwound from the first roll 111 is conveyed through the first conveyance route 48 to reach the recording part 30, the first cutting part 61, the bonding part 50, and the second cutting part 62 in that order. A direction of travelling of the first sheet 101 is a conveyance direction 19. The second sheet 102 unwound from the second roll 121 reaches the second cutting part 62 through the second conveyance route 49 and via the bonding part 50. In the second conveyance route 49, a guide 93 is disposed upstream in the conveyance direction 19 of the bonding part 50. The guide 93 constructs a lower guide surface of the second conveyance route 49.

### Recording Part 30

The recording part 30 is disposed downstream in the conveyance direction 19 of the first conveyance route 48 relative to the first roll 111. The recording part 30 is disposed below the first roll 111 and the second roll 121 in the up-down direction and in rear of the first cutting part 61 in the front-rear direction. The recording part 30 includes a carriage 31 and a recording head 32. Although not illustrated in each drawing, the main body 11 includes two guide rails extending in the left-right direction in the internal space. The carriage 31 is mounted on the two guide rails. The carriage 31 receives a driving force from a motor for CR 209 and moves in the left-right direction.

The recording head 32 is mounted on the carriage 31. The recording head 32 has a nozzle surface 32A facing downward. The recording head 32 has a plurality of nozzles 33. The plurality of nozzles 33 opens in the nozzle surface 32A. As the carriage 31 moves, the recording head 32 moves in the left-right direction. A platen 34 is disposed below the recording head 32. The platen 34 supports the first sheet 101. The recording head 32 selectively ejects ink downward from the nozzles 33 while moving in the left-right direction. The ink ejected from the nozzles 33 adheres to the recording surface 107 of the first sheet 101. In this manner, the recording part 30 records an image onto the recording surface 107 of the first sheet 101 drawn out from the first roll 111.

First Conveyance Rollers 41 to Fourth Conveyance Rollers 44

The first conveyance rollers 41 are disposed above the second conveyance rollers 42 in the up-down direction and in rear of the second conveyance rollers 42 in the front-rear direction. The second conveyance rollers 42 are disposed in rear of the recording part 30 in the front-rear direction. The third conveyance rollers 43 and the fourth conveyance rollers 44 are disposed between the recording part 30 and the bonding part 50 in the front-rear direction. The fourth conveyance rollers 44 are disposed in front of the third conveyance rollers 43 in the front-rear direction.

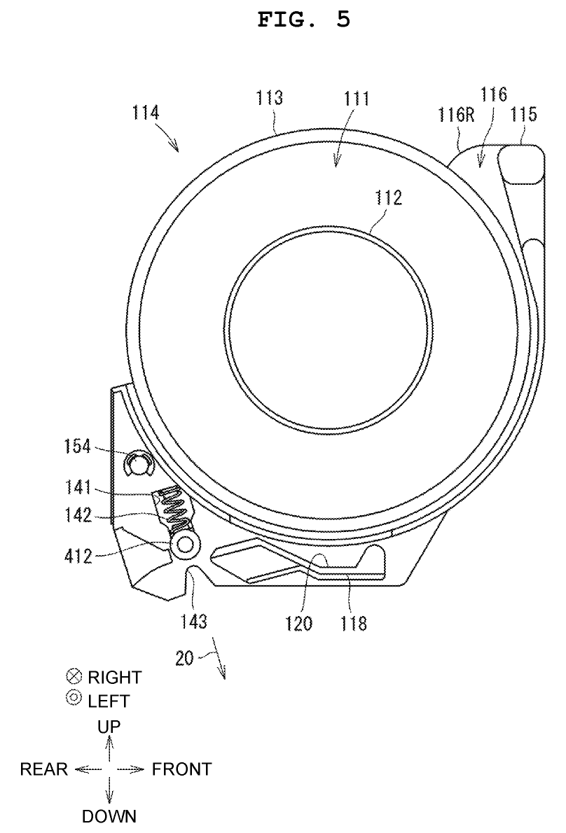

The first conveyance rollers 41 includes a first roller 411 and a second roller 412. The first roller 411 is supported by the left frame 77 and the right frame 78 in the main body 11. The second roller 412 is supported by the first cartridge 114 (see FIG. 5). The first roller 411 is located diagonally downward and forward of the second roller 412. The first sheet 101 is gripped between the first roller 411 and the second roller 412. At a position between the first conveyance rollers 41 and the second conveyance rollers 42, the first conveyance route 48 curves downward, reversing from a backward direction to a forward direction. The first roller 411 receives a driving force from a motor for conveyance 207 and rotates about an axis extending in the left-right direction. In response to a rotation of the first roller 411, the first sheet 101 is conveyed in the conveyance direction 19. As the first sheet 101 is conveyed in the conveyance direction 19, the second roller 412 rotates about an axis extending in the left-right direction.

The second conveyance rollers 42 include a third roller 421 and a fourth roller 422. The third roller 421 and the fourth roller 422 are supported by the left frame 77 and the right frame 78 (see FIG. 3 and FIG. 4) of the main body 11. The third roller 421 is located directly above the fourth roller 422. The first sheet 101 is gripped between the third roller 421 and the fourth roller 422. The fourth roller 422 receives a driving force from the motor for conveyance 207 and rotates about an axis extending in the left-right direction. The first sheet 101 is conveyed in the conveyance direction 19 by a rotation of the fourth roller 422. As the first sheet 101 is conveyed in the conveyance direction 19, the third roller 421 rotates about an axis extending in the left-right direction. The conveyance direction 19 is orthogonal to the left-right direction.

In an area between the first conveyance rollers 41 and the second conveyance rollers 42, the first conveyance route 48 curves downward, reversing from a backward direction to a forward direction. The curved section of the first conveyance route 48 is the curved section 48B. The curved section 48B is a route between the guide member 45 and the guide member 46 each having curved guide surface.

The third conveyance rollers 43 include a fifth roller 431 and a sixth roller 432. The fourth conveyance rollers 44 include a seventh roller 441 and an eighth roller 442. Because configuration and function of the third conveyance rollers 43 and the fourth conveyance rollers 44 are the same as those of the second conveyor rollers 42, detailed description is omitted.

Note that, regarding two rollers constructing each of the first conveyance rollers 41 to the fourth conveyance rollers 44, a roller that receives a driving force from the motor for conveyance 207 may be any one of the two rollers.

### Bonding Part 50

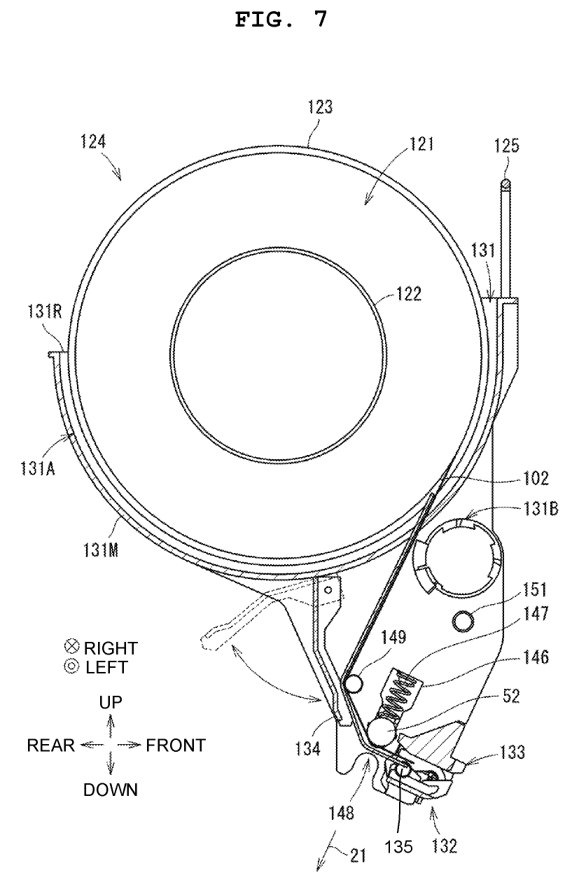

As illustrated in FIG. 3 and FIG. 4, the bonding part 50 is disposed downstream in the conveyance direction 19 of the first conveyance route 48 relative to the recording part 30. In the front-rear direction, the bonding part 50 is disposed between the first cutting part 61 and the second cutting part 62. The bonding part 50 includes a first bonding roller 51 and a second bonding roller 52. The first bonding roller 51 is supported by the left frame 77 and the right frame 78 of the main body 11. As illustrated in FIG. 7, the second bonding roller 52 is supported by the second cartridge 124 (see FIG. 7). The first bonding roller 51 is located in rear of and below the second bonding roller 52. The first sheet 101 and the second sheet 102 pass between the first bonding roller 51 and the second bonding roller 52. In a state that the second cartridge 124 is mounted to the internal space of the laminating apparatus 1, the recording surface 107 of the first sheet 101 faces upward, and the bonding surface 109 of the second sheet 102 faces downward. Therefore, the second bonding roller 52 contacts the release sheet 106 of the second sheet 102. The bonding part 50 is an example of a bonding part.

The first bonding roller 51 receives a driving force from a motor for bonding 208 and rotates about an axis extending in the left-right direction. In response to a rotation of the first bonding roller 51, the first sheet 101 and the second sheet 102 are conveyed in the conveyance direction 19. As the first sheet 101 and the second sheet 102 are conveyed in the conveyance direction 19, the second bonding roller 52 also rotates about an axis extending in the left-right direction.

The second bonding roller 52 is biased toward the first bonding roller 51 by a coil spring 147. The first bonding roller 51 and the second bonding roller 52 pinch the first sheet 101 and the second sheet 102. This causes the recording surface 107 of the first sheet 101 and the bonding surface 109 of the second sheet 102 to contact closely, thereby bonding the first sheet 101 and the second sheet 102 together.

### First Cutting Part 61 and Second Cutting Part 62

As illustrated in FIG. 3 and FIG. 4, the first cutting part 61 is disposed, in the conveyance direction 19 of the first conveyance route 48, downstream of the recording part 30 and upstream of the bonding part 50. The first cutting part 61 is disposed between the fourth conveyance rollers 44 and the bonding part 50 in the front-rear direction. The first cutting part 61 cuts the first sheet 101 at a position between the fourth conveyance rollers 44 and the bonding part 50. The first cutting part 61 is an example of a cutting part.

The second cutting part 62 is disposed downstream of the bonding part 50 in the conveyance direction 19 of the second conveyance route 49. The second cutting part 62 is disposed in front of the bonding part 50 in the front-rear direction. The second cutting part 62 simultaneously cuts the first sheet 101 and the second sheet 102 bonded together at the bonding part 50. The second cutting part 62 has a configuration capable of cutting the first sheet 101 and the second sheet 102.

### First Cutting Part 61

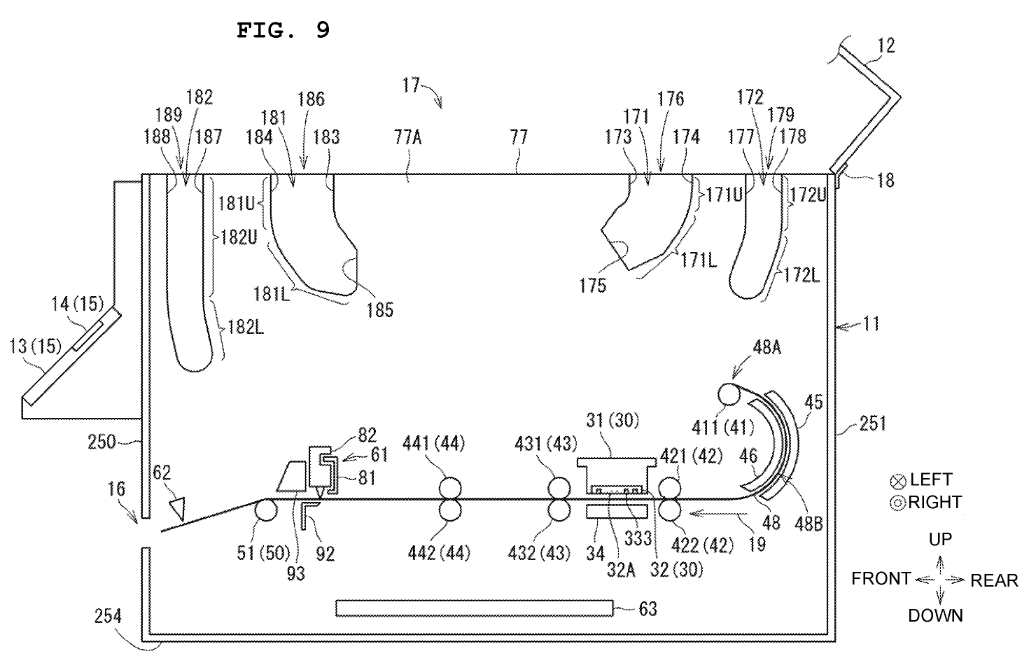

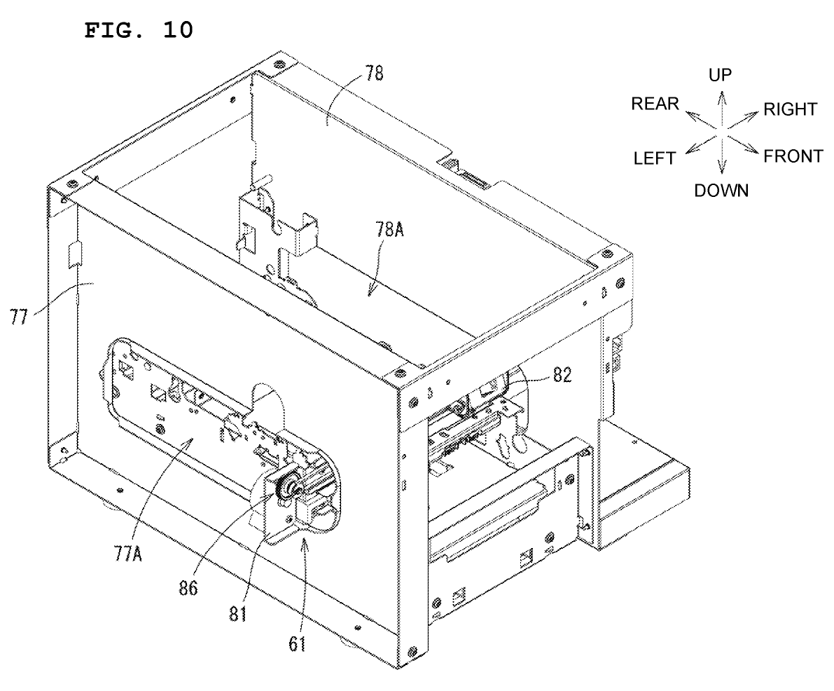

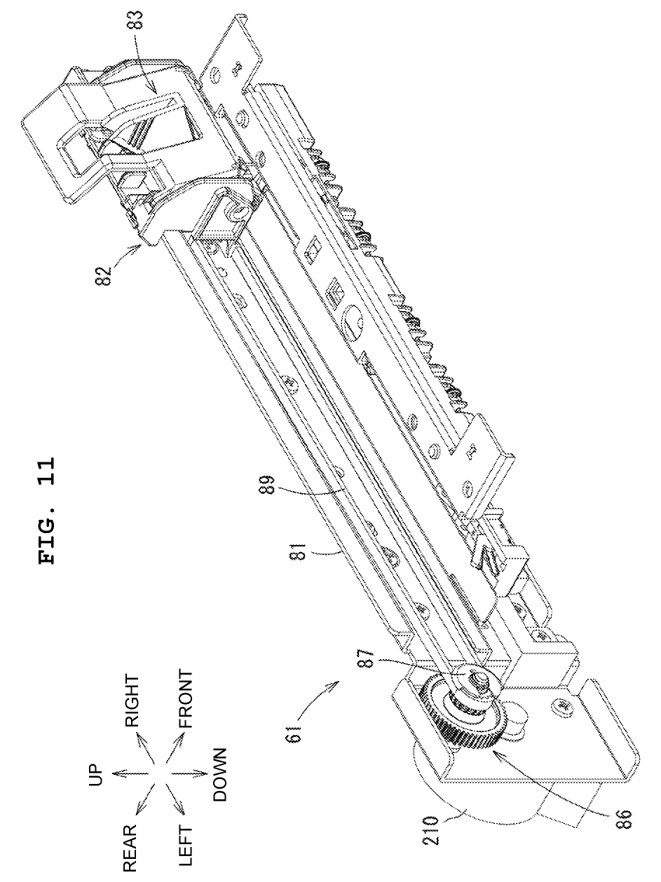

As illustrated in FIG. 3, FIG. 4, FIG. 10, and FIG. 11, the first cutting part 61 includes a guide rail 81 extending along the left-right direction, a cutter carriage 82 configured to move while being guided by the guide rail 81, a cutter unit 83 mounted on the cutter carriage 82, and a fixed blade 92. The cutter carriage 82 is an example of a carriage. In FIG. 3, FIG. 4, and FIG. 9, the first cutting part 61 is illustrated schematically with its detailed configuration omitted.

As illustrated in FIG. 10, a lower portion of the left frame 77 has an opening 77A that penetrates the left frame 77. A lower portion of the right frame 78 has an opening 78A that penetrates the right frame 78.

The guide rail 81 has a flat shape extending along the left-right direction. The guide rail 81 is formed, for example, by bending and notching a single rectangular steel plate. The guide rail 81 extends substantially in the up-down direction and the left-right direction. A length in the left-right direction of the guide rail 81 is longer than a length in the left-right direction between the left frame 77 and the right frame 78. The guide rail 81 extends through the opening 77A of the left frame 77, and thus the left end of the guide rail 81 is disposed on the left of the left frame 77. Furthermore, the guide rail 81 extends through the opening 78A of the right frame 78, and thus the right end of the guide rail 81 is disposed on the right of the right frame 78. The guide rail 81 is fixed to the left frame 77 and the right frame 78 at the opening 77A and the opening 78A, respectively.

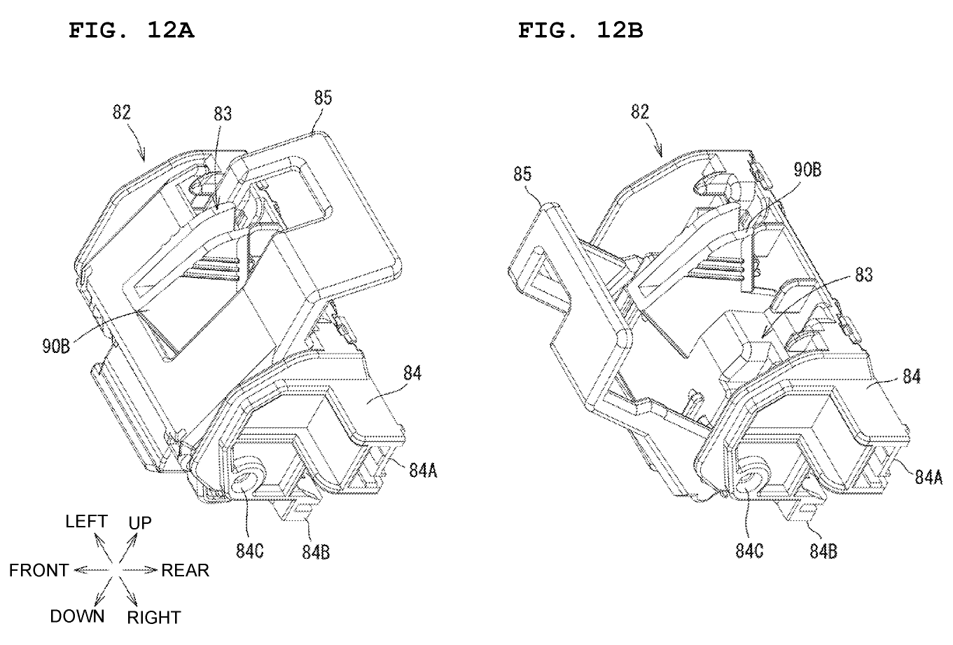

As illustrated in FIG. 11 and FIGS. 12A and 12B, the cutter carriage 82 includes a main body 84 configured to hold the cutter unit 83, and a lever 85. The main body 84 has a box-shape opening upwardly. Although not illustrated in the drawings, the main body 84 has a slit opening downward and extending in the left-right direction. An engagement part 84A is located on a front surface of the main body 84. The engagement part 84A opens rearward. An engagement of the engagement part 84A with the guide rail 81 allows the main body 84 to move in the left-right direction along the guide rail 81. A holding part 84B is located on a bottom surface of the main body 84. The holding part 84B holds an endless belt 89 of a driving mechanism 86. With this configuration, the main body 84 moves in the left-right direction together with the endless belt 89. The cutter carriage 82 terminates its movement at a right end portion of the guide rail 81. That is, a left end portion of the guide rail 81 is an example of a standby position of the cutter carriage 82. The standby position of the cutter carriage 82 may be the right end portion of the guide rail.

The lever 85 is pivotable relative to the main body 84. Although not illustrated in the drawings, a shaft protruding in the left-right direction is disposed at a rear end portion of the lever 85, and the shaft is inserted into a bearing part 84C of the main body 84. The lever 85 can pivot about the shaft to move between a first position, illustrated in FIG. 12A, where the lever 85 closes an upward opening of the body 84, and a second position, illustrated in FIG. 12B, where the lever 85 opens the upward opening of the main body 84. The lever 85 located at the first position presses the cutter unit 83 accommodated in the main body 84 from above to hold the cutter unit 83 in the main body 84. The lever 85 located at the second position allows the cutter unit 83 accommodated in the main body 84 to be removed from the main body 84.

The cutter carriage 82 is driven by the driving mechanism 86. The driving mechanism 86 includes a driving pulley 87 and a driven pulley (not illustrated) supported by the guide rail 81, an endless belt 89 spanned between the driving pulley 87 and the driven pulley, and a cutter motor 210. The driving pulley 87 is disposed near a left end of the guide rail 81 in the left-right direction. The driven pulley is disposed near a right end of the guide rail 81 in the left-right direction, but is not visible in FIG. 11 because the driven pulley is hidden by the cutter carriage 82. Each of the driving pulley 87 and the driven pulley rotates about an axis extending along the front-rear direction.

A cutter motor 210 is disposed near the left end of the guide rail 81. A driving force from the cutter motor 210 is transmitted to the driving pulley 87, causing the driving pulley 87 to rotate.

The endless belt 89 is connected to the holding part 84B of the cutter carriage 82. As the driving pulley 87 rotates, the endless belt 89 moves, causing the unillustrated driven pulley to follow. A movement of the endless belt 89 causes the cutter carriage 82 to move in the left-right direction along the guide rail 81. The cutter carriage 82 enters the opening 77A of the left frame 77 at a position near the left end of the guide rail 81. The cutter carriage 82 enters the opening 78A of the right frame 78 at a position near the right end of the guide rail 81.

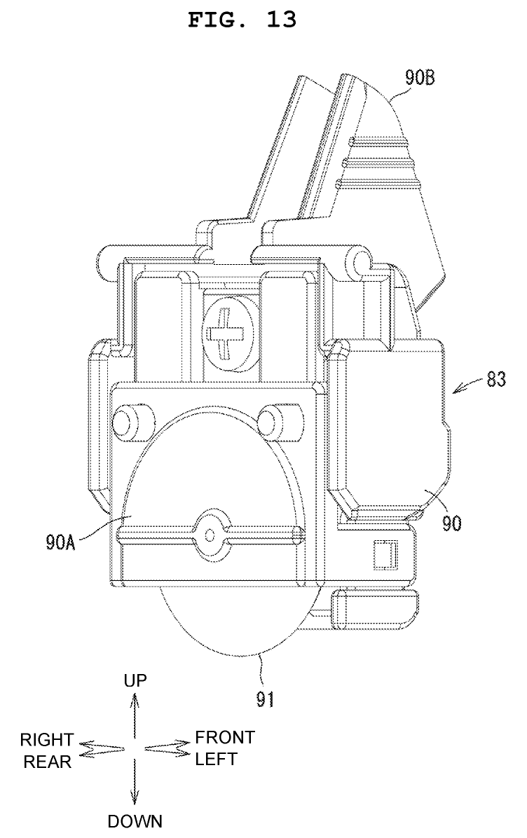

As illustrated in FIG. 13, the cutter unit 83 includes a holder 90 and a cutter 91. The holder 90 can be accommodated in the main body 84 of the cutter carriage 82. The cutter 91 is disc-shaped and has a blade along its periphery. The holder 90 has a holding portion 90A configured to hold the cutter 91 and a grip portion 90B. The holding portion 90A sandwiches the cutter 91 in the front-rear direction. The cutter 91 can rotate about an axis in a state that the cutter 91 is sandwiched by the holding portion 90A. A portion of the cutter 91 protrudes below a lower surface of the holder 90. In a state that the cutter unit 83 is accommodated in the main body 84 of the cutter carriage 82, a portion of the cutter 91 protrudes downward from a lower surface of the main body 84, passing through the slit in the main body 84.

As illustrated in FIG. 3 and FIG. 4, a fixed blade 92 is disposed below the cutter carriage 82. The fixed blade 92 extends in the left-right direction, supported by the guide rail 81. An edge of the fixed blade 92 faces rearward. The cutter 91 contacts the edge of the fixed blade 92 from the rear. The first sheet 101 is cut by being interposed between the cutter 91 and the fixed blade 92. Note that the second cutting part 62 may, for example, include a cutter carriage 82 configured to move in the left-right direction by receiving a driving force from a motor for cutting and a cutter 91 mounted on the cutter carriage 82. Alternatively, the second cutting part 62 may include a movable blade configured to move in the up-down direction by receiving a driving force from a motor for cutting and a fixed blade facing the movable blade.

### Guide 93

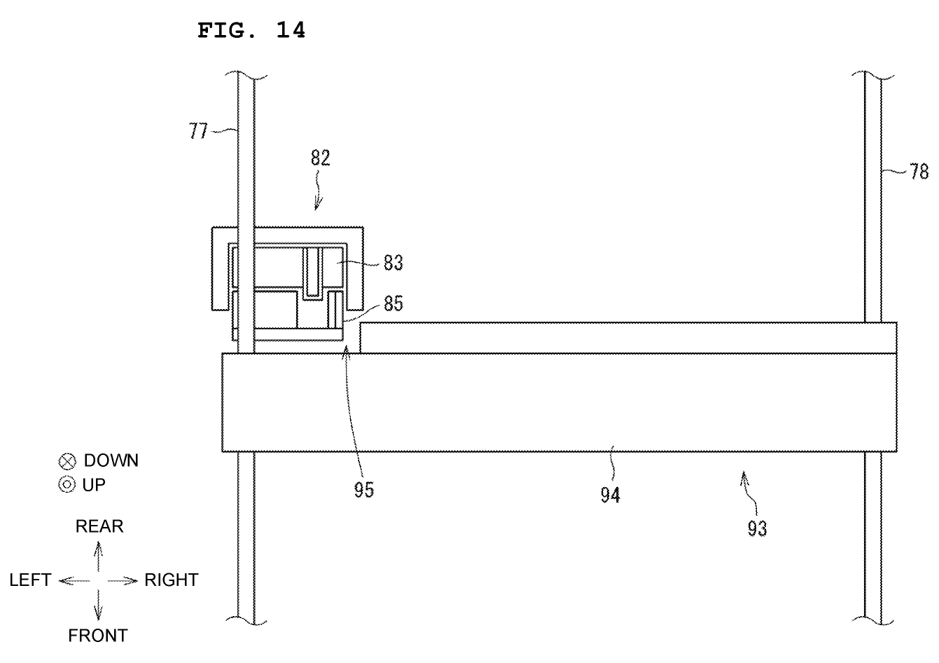

As illustrated in FIG. 14, the guide 93 constructs a lower guide surface of the second conveyance route 49. The guide 93 extends in the left-right direction, supported by the left frame 77 and the right frame 78. An upper surface 94 of the guide 93 defines a portion of the second conveyance route 49. At a right end portion of the guide 93, a recess 95 which is recessed forward from a rear end of the guide 93 is defined. A length in the left-right direction of the recess 95 is slightly greater than a length in the left-right direction of the lever 85 of the cutter carriage 82. The lever 85 located at the second position enters into the recess 95.

### Control Board 63

As illustrated in FIG. 3 and FIG. 4, the control board 63 is disposed below the recording part 30 and the first conveyance route 48. The control board 63 is a circuit board on which electronic components are mounted. Based on, for example, programs pre-recorded in for example memories and signals from un-illustrated sensors, the control board 63 controls operations of the carriage 31 and the recording head 32 of the recording part 30, the first conveyance rollers 41 to the fourth conveyance rollers 44, the bonding part 50, the first cutting part 61, and the second cutting part 62. The controller 200 configured by the control board 63 is described below.

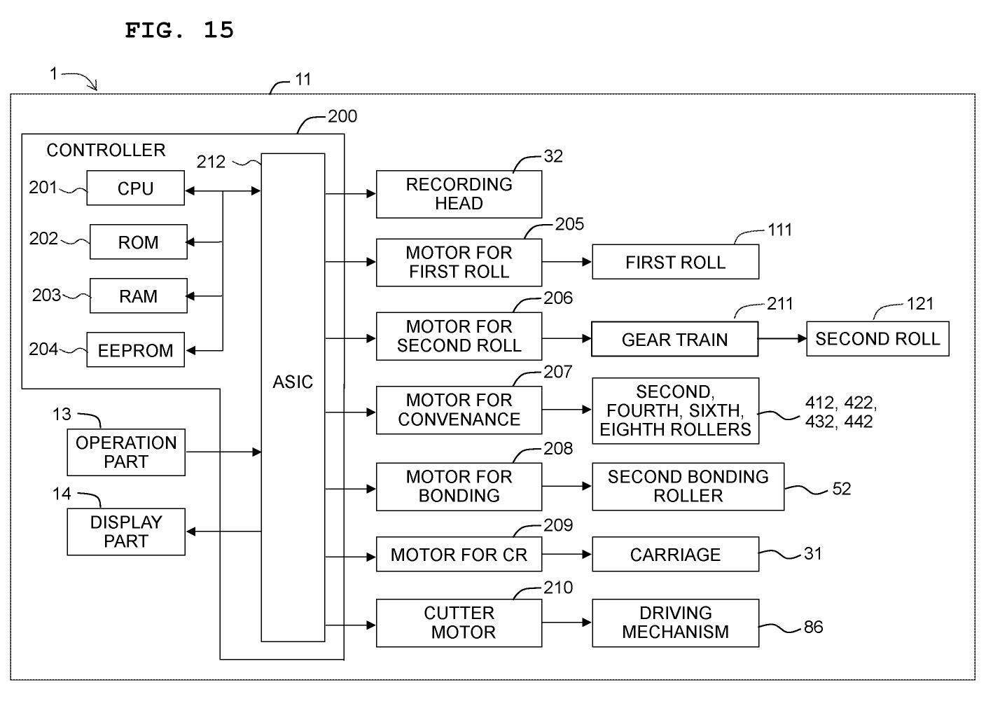

As illustrated in FIG. 15, the controller 200 includes a CPU 201, a ROM 202, a RAM 203, and an EEPROM 204. The ROM 202 stores, for example, programs for controlling various operations of the laminating apparatus 1. The EEPROM 204 stores various data used in a case where the above programs are executed. The RAM 203 is used as a memory area for temporarily storing various data used by the CPU 201 in a case where the CPU 201 executes the above programs, and as an expansion area for data and programs. In a case where the laminating apparatus 1 is powered on, the programs stored in the ROM 202 are copied and transferred to the RAM 203. The CPU 201 executes the programs stored in the RAM 203. With this process, the controller 200 performs various controls.

The operation part 13 and the display part 14 are connected to the ASIC 212. The operation part 13 detects pressing of operation keys and outputs a signal corresponding to a pressed operation key. The controller 200 identifies the pressed operation key based on an output signal from the operation part 13. The display part 14 displays information regarding an operation of the laminating apparatus 1 on a screen based on instructions from the controller 200.

The recording head 32 is connected to the ASIC 212. The controller 200 outputs signals corresponding to image data to the recording head 32 via the ASIC 212. The recording head 32 ejects ink from a plurality of nozzles 33 disposed on the recording head 32 in response to the signals output from the controller 200.

### Various Motors

The ASIC 212 is connected to a motor for first roll 205, a motor for second roll 206, the motor for conveyance 207, the motor for bonding 208, the motor for CR 209, and the cutter motor 210. A driving circuits to control these motors are incorporated into the ASIC 212. Regarding each of those motors, the controller 200 outputs drive signal for rotating one of those motors to a drive circuit corresponding to the one of those motors. The driving circuit outputs driving current corresponding to the drive signal output from the controller 200 to a corresponding motor. Thus, the corresponding motor rotates.

The motor for first roll 205 generates power to rotate the first roll 111. The motor for second roll 206 generates power to rotate the second roll 121. A rotation of the motor for second roll 206 is transmitted to a gear train 211, and a rotation of the gear train 211 is transmitted to the second shaft 122 of the second roll 121. As illustrated in FIG. 3, the gear train 211 is connected to the second shaft 122 at a right end side of the second shaft 122. The gear train 211 is configured with a plurality of gears supported by the right frame 78. Note that in FIG. 3, individual gears are not illustrated, and an arrangement of the gear train 211 is indicated by dashed lines. The recess 95, and consequently the replacement position is located at the right end side in the left-right direction and the gear train 211 is located at the left end side in the left-right direction. Thus, a user is less likely to touch the gear train in performing replacement of the cutter unit 83, resulting in reducing of possibility of injury.

The motor for conveyance 207 generates power to rotate the second roller 412, the fourth roller 422, the sixth roller 432, and the eighth roller 442. The motor for bonding 208 generates power to rotate the second bonding roller 52. The motor for CR 209 generates power to move the carriage 31 in the left-right direction. The cutter motor 210 generates power to operate the driving mechanism 86. Note that in FIG. 15, a drive source for driving the second cutting part 62 is omitted. However, depending on a configuration of the second cutting part 62, a driving source such as a motor may be controlled by a controller, or the second cutting part 62 may be driven by any of the motors.

### First Cartridge 114, Second Cartridge 124

As illustrated in FIG. 3, FIG. 4, and FIG. 5, the first cartridge 114 has the second roller 412, an accommodating part 116 configured to accommodate the first roll 111 in which the first sheet 101 is wound, and a guide 118. The first roll 111 is attachable to and detachable from the accommodating part 116 of the first cartridge 114. The first roll 111 is wound with the recording surface 107 facing outward and the back surface 108 facing inward.

The second cartridge 124 includes the second bonding roller 52, an accommodating part 131, a movable guide 132, a fixed guide 133, and a cover 134. The accommodating part 131 of the second cartridge 124 is configured to accommodate the second roll 121 in which the second sheet 102 is wound. The second roll 121 is attachable to and detachable from the accommodating part 131 of the second cartridge 124. The second roll 121 is wound in a state that the first adhesive layer 103 of the second sheet 102 faces inward and the release sheet 106 faces outward.

### First Cartridge 114

The accommodating part 116 is a box having an opening that opens upward. The accommodating part 116 has a left wall 116L and a right wall 116R apart from each other in the left-right direction. In the left-right direction, the first roll 111, the second roller 412, and the guide 118 are disposed in a space between the left wall 116L and the right wall 116R.

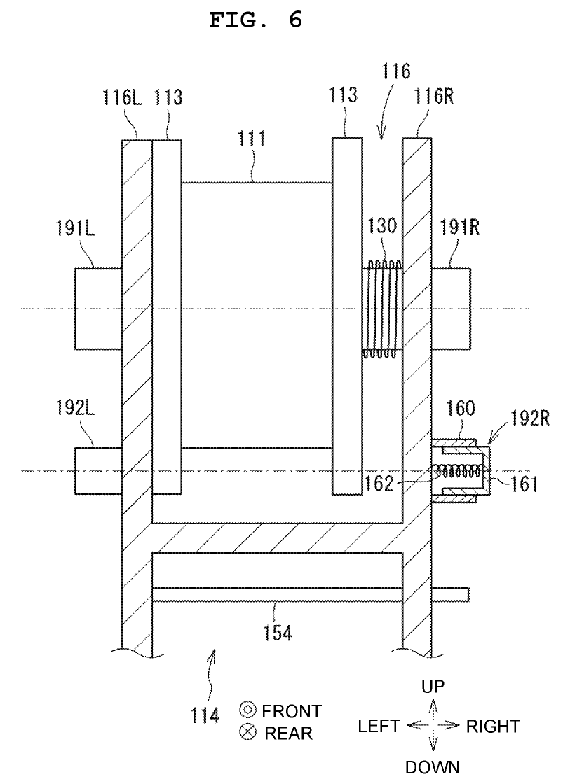

The first roll 111 is to be accommodated in the internal space of the accommodating part 116 in a state that an axis direction of the first roll 111 matches the left-right direction. As illustrated in FIG. 6, the first roll 111 is to be accommodated in the internal space of the accommodating part 116 in a state that both ends in the left-right direction of the first roll 111 is interposed between the flanges 113. In a state that the first roll 111 is accommodated in the internal space of the accommodating part 116, the first roll 111 is rotatable about an axis extending in the left-right direction.

As illustrated in FIG. 6, the first cartridge 114 has a spring 130. The spring 130 is disposed between the flange 113 on the right of the first roll 111 and the right wall 116R of the first cartridge 114. The first roll 111 is biased leftward by the spring 130. Thus, the flange 113 on the left of the first roll 111 is in contact with the left wall 116L of the accommodating part 116. That is, the left wall 116L serves as a reference for positioning the first roll 111 in the left-right direction.

As illustrated in FIG. 3, FIG. 4, and FIG. 6, the first cartridge 114 has a protrusion 191L, a protrusion 192L, a protrusion 191R, and a protrusion 192R. The protrusion 191L and the protrusion 192L protrude leftward from the left wall 116L of the accommodating part 116. The protrusion 191R and the protrusion 192R protrude to the right from the right wall 116R of the accommodating part 116.

The protrusion 191L and the protrusion 191R are located on the same axis. The axis of the first roll 111 is located on the axis of the protrusion 191L and the protrusion 191R.

The protrusion 192L and the protrusion 192R are located on the same straight line. In the up-down direction, the protrusion 192L and the protrusion 192R are located below the protrusion 191L and the protrusion 191R. That is, the protrusion 192L and the protrusion 192R are separated from the axis of the first roll 111.

As illustrated in FIG. 6, the protrusion 192R includes an outer cylinder 160, an inner cylinder 161, and a coil spring 162. The outer cylinder 160 protrudes to the right from the right wall 116R of the accommodating part 116. The inner cylinder 161 is disposed in an internal space of the outer cylinder 160 and is movable in the left-right direction along an inner surface of the outer cylinder 160. An outer diameter of the inner cylinder 161 is slightly smaller than an inner diameter of the outer cylinder 160. The coil spring 162 is disposed in the internal space of the outer cylinder 160. One end of the coil spring 162 contacts the right wall 116R, and the other end of the coil spring 162 contacts the inner cylinder 161. The coil spring 162 biases the inner cylinder 161 to the right. A right end of the inner cylinder 161 is positioned on the right of a right end of the outer cylinder 160.

As illustrated in FIG. 5, the guide 118 is disposed near a lower end of the accommodating part 116. The guide 118 is supported by the left wall 116L and the right wall 116R of the accommodating part 116. The guide 118 is an elongated member extending in the left-right direction. The guide 118 has ribs 120 protruding upward and extending in the front-rear direction. The ribs 120 are arranged at intervals in the left-right direction. The number and spacing of the ribs 120 are set appropriately.

As illustrated in FIG. 5, the second roller 412 is disposed in rear of the guide 118. The second roller 412 is supported by the left wall 116L and the right wall 116R of the accommodating part 116. The second roller 412 is rotatable about an axis extending in the left-right direction. In a state that the first cartridge 114 is mounted to the main body 11, the second roller 412 faces the first roller 411 along a facing direction 20. As illustrated in FIG. 5, the left wall 116L and right wall 116R of the accommodating part 116 each have an elongated hole 141 extending along the facing direction 20, through which a shaft of the second roller 412 can pass. Thus, the second roller 412 is movable along the facing direction 20.

The first cartridge 114 includes the elongated holes 141, coil springs 142, and engagement grooves 143. The coil springs 142 are disposed in the elongated holes 141. The coil springs 142 bias the second roller 412 downward in the facing direction 20. The engagement grooves 143 are located at a lower end of the left wall 116L and a lower end of the right wall 116R of the accommodating part 116, and below the elongated holes 141 in the facing direction 20. Lower ends of the engagement grooves 143 are opened. The engagement grooves 143 engage with a shaft of the first roller 411. With this configuration, the shaft of the first roller 411 is positioned relative to the left wall 116L and the right wall 116R of the accommodating part 116. Consequently, the second roller 412 contacts the first roller 411 in a state that the shafts of the first roller 411 and the second roller 412 are parallel to each other.

As illustrated in FIG. 4 and FIG. 5, the accommodating part 116 of the first cartridge 114 has a shaft 154. The shaft 154 is supported by the left wall 116L and the right wall 116R of the accommodating part 116, with its axis extending in the left-right direction. The right end of the shaft 154 protrudes to the right from the right wall 116R.

As illustrated in FIG. 4, the main body 11 has a lock lever 155 and a coil spring 156. The lock lever 155 is disposed in the internal space of the main body 11. The lock lever 155 has a hook-shape and is pivotable about an axis extending along the left-right direction at a lower end side of the lock lever 155. In a state that the first cartridge 114 is mounted on the main body 11, the lock lever 155 engages an upper side of the shaft 154 to prevent the first cartridge 114 from moving upward. The lock lever 155 can be operated by a user via a known configuration such as a slide cam.

As illustrated in FIG. 4, the lock lever 155 is biased counterclockwise in FIG. 4 by the coil spring 156. With the biasing force of the coil spring 156, the lock lever 155 biases the shaft 154 in the facing direction 20. With this configuration, the second roller 412 is biased toward the first roller 411.

As illustrated in FIG. 5, the first cartridge 114 has a handle 115. The handle 115 protrudes upward from a front end of the accommodating part 116. A user can attach or detach the first cartridge 114 with respect to the internal space of the laminating apparatus 1 by operating the first cartridge 114 while grasping the handle 115 of the first cartridge 114.

### Second Cartridge 124

The accommodating part 131 is a box having an opening opened upwardly. The accommodating part 131 has a left wall 131L and a right wall 131R separated in the left-right direction. In the left-right direction, the second bonding roller 52, the movable guide 132, the fixed guide 133, and the cover 134 are disposed in a space between the left wall 131L and the right wall 131R.

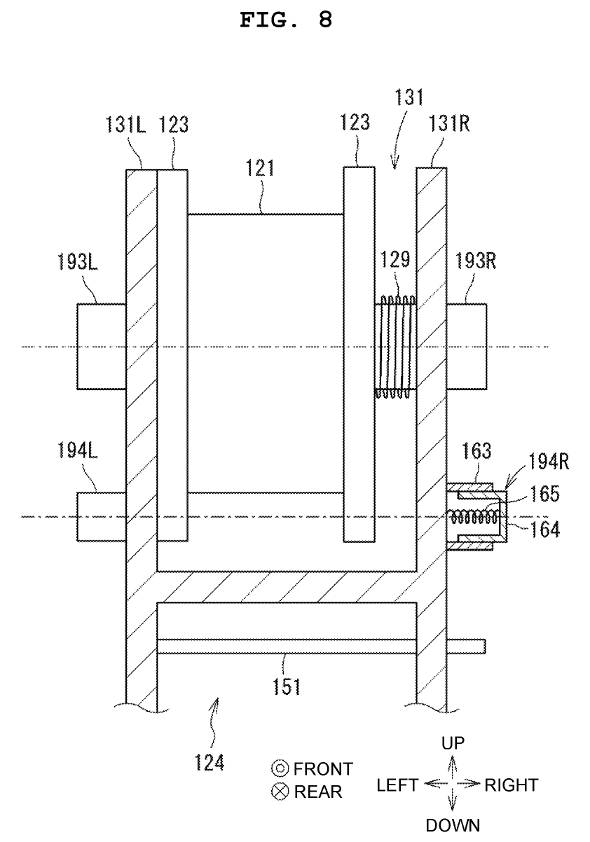

The second roll 121 is to be accommodated in an internal space of the accommodating part 131 in a state that an axis of the second roll 121 extends in the left-right direction. As illustrated in FIG. 8, the second sheet 102 of the second roll 121 is to be accommodated in the internal space of the accommodating part 131 in a state that both ends in the left-right direction of the second sheet 102 is interposed between the flanges 123. In a state that the second roll 121 is accommodated in the internal space of the accommodating part 131, the second roll 121 is rotatable about an axis.

As illustrated in FIG. 8, the second cartridge 124 has a spring 129 disposed between the flange 123 on the right of the second roll 121 and a right wall 131R of the second cartridge 124. The second roll 121 is biased leftward by the spring 129. Thus, the flange 123 on the left of the second roll 121 contacts a left wall 131L of the accommodating part 131. That is, the left wall 131L serves as a reference for positioning the second roll 121 in the left-right direction in the accommodating part 131.

As illustrated in FIG. 3, FIG. 4, and FIG. 8, the second cartridge 124 has a protrusion 193L, a protrusion 193R, a protrusion 194L, and a protrusion 194R. The protrusion 193L is disposed on the left wall 131L of the accommodating part 131 and protrudes to the left. The protrusion 193R is disposed on the right wall 131R of the accommodating part 131 and protrudes to the right. The protrusion 193L and the protrusion 193R are located on the same axis. The axis of the second roll 121 is located on the axis of the protrusion 193L and the protrusion 193R.

As illustrated in FIG. 3, FIG. 4, and FIG. 8, the protrusion 194L is disposed on the left wall 131L of the accommodating part 131 and protrudes to the left. The protrusion 194R is disposed on the right wall 131R of the accommodating part 131 and protrudes to the right. The protrusion 194L and the protrusion 194R are located on the same axis. The protrusion 194L and the protrusion 194R are disposed below the protrusion 193L and the protrusion 193R. That is, the protrusion 194L and the protrusion 194R are separated from the axis of the second roll 121.

As illustrated in FIG. 8, the protrusion 194R includes an outer cylinder 163, an inner cylinder 164, and a coil spring 165. The outer cylinder 163 protrudes to the right from the right wall 131R of the accommodating part 131. The inner cylinder 164 is disposed in an internal space of the outer cylinder 163 and is movable in the left-right direction along an inner surface of the outer cylinder 163. An outer diameter of the inner cylinder 164 is slightly smaller than an inner diameter of the outer cylinder 163. The coil spring 165 is disposed in the internal space of the outer cylinder 163. One end of the coil spring 165 contacts the right wall 131R, and the other end of the coil spring 165 contacts the inner cylinder 164. The inner cylinder 164 is biased to the right by the coil spring 165. A right end of the inner cylinder 164 is disposed on the right of a right end of the outer cylinder 163.

As illustrated in FIG. 7, the movable guide 132 is disposed near a lower end of the accommodating part 131. The movable guide 132 is supported pivotably about a shaft 135 at a position between the left wall 131L and the right wall 131R of the accommodating part 131.

As illustrated in FIG. 7, a fixed guide 133 is disposed near the lower end of the accommodating part 131 and above the movable guide 132. The fixed guide 133 is supported by the left wall 131L and the right wall 131R of the accommodating part 131. The fixed guide 133 faces the movable guide 132 in a facing direction 21 described below.

Based on a rotation of the movable guide 132, the second sheet 102 transitions between a state in which the second sheet 102 cannot pass between the movable guide 132 and the fixed guide 133 and a state in which the second sheet 102 can pass between the movable guide 132 and the fixed guide 133.

As illustrated in FIG. 7, the second bonding roller 52 is located in rear of the fixed guide 133. The second bonding roller 52 is rotatably supported by the left wall 131L and the right wall 131R of the accommodating part 131. An axis of the second bonding roller 52 extends in the left-right direction. In a state that the second cartridge 124 is mounted to the main body 11, the second bonding roller 52 faces the first bonding roller 51 in the facing direction 21. The left wall 131L and the right wall 131R of the accommodating part 131 each have an elongated hole 146 extending along the facing direction 21, through which a shaft of the second bonding roller 52 can pass. Thus, the second bonding roller 52 is movable along the facing direction 21.

The second cartridge 124 has coil springs 147. The coil springs 147 are positioned in the elongated holes 146. The coil springs 147 bias the second bonding roller 52 downward in the facing direction 21. At lower ends of the left wall 131L and the right wall 131R of the accommodating part 131 and positions below the elongated holes 146 in the facing direction 21, engagement grooves 148 opening downward are disposed. The engagement grooves 148 engage with a shaft of the first bonding roller 51. With this configuration, the shaft of the first bonding roller 51 is positioned relative to the left wall 131L and the right wall 131R of the accommodating part 131. Consequently, the second bonding roller 52 contacts the first bonding roller 51 in a state that the first bonding roller 51 and the second bonding roller 52 face each other in the facing direction 21 with the shafts of the first bonding roller 51 and the second bonding roller 52 being parallel to each other.

As illustrated in FIG. 7, the second cartridge 124 has a roller 149. The roller 149 is disposed above and in rear of the second bonding roller 52. The roller 149 is rotatably supported by the left wall 131L and the right wall 131R of the accommodating part 131 in a state that an axis direction of the roller 149 matches the left-right direction. The roller 149 faces the release sheet 106 of the second sheet 102.

As illustrated in FIG. 7, a cover 134 is disposed in rear of the roller 149 and below the second roll 121. The cover 134 covers an area in rear of the second sheet 102 from a position below the second roll 121 to a position above the movable guide 132. The cover 134 faces the first adhesive layer 103 of the second sheet 102.

As illustrated by a dashed line in FIG. 7, the cover 134 pivots about an upper end portion of the cover 134, such that a lower end portion of the cover 134 moves rearward. In a case where the cover 134 is located at a position indicated by the dashed line in FIG. 7, the first adhesive layer 103 of the second sheet 102 is exposed rearward, facilitating access to the second sheet 102 from the rear of the second cartridge 124. Although not illustrated in the drawings, a surface of the cover 134 facing the first adhesive layer 103 of the second sheet 102 may have rib(s) or a coating layer exhibiting fine mold release properties with respect to the first adhesive layer 103.

As illustrated in FIG. 7, the second cartridge 124 has a shaft 151. The shaft 151 is disposed in the accommodating part 131. In the accommodating part 131, the shaft 151 is supported by the left wall 131L and the right wall 131R, with an axial direction of the shaft 151 extending along the left-right direction. A right end of the shaft 151 protrudes to the right from the right wall 131R.

As illustrated in FIG. 4, the main body 11 has a lock lever 152 and a coil spring 153. The lock lever 152 is disposed in the internal space of the main body 11. The lock lever 152 has a hook-shape and is pivotable about an axis at a lower end side of the lock lever 152 extending in the left-right direction. In a state that the second cartridge 124 is mounted to the main body 11, the lock lever 152 engages an upper side of the shaft 151 to prevent the second cartridge 124 from moving upward. The lock lever 152 can be operated by a user via a known configuration such as a slide cam.

As illustrated in FIG. 4, the lock lever 152 is biased clockwise in FIG. 4 by the coil spring 153. With a biasing force of the coil spring 153, the lock lever 152 biases the shaft 151 in the facing direction 21. With this configuration, the second bonding roller 52 is biased toward the first bonding roller 51.

As illustrated in FIG. 7, the second cartridge 124 has a handle 125. The handle 125 protrudes upward from a front end of the accommodating part 131. A user can attach and detach the second cartridge 124 with respect to the internal space of the laminating apparatus 1 by operating the second cartridge 124 while grasping the handle 125 of the second cartridge 124. The handle 115 and the handle 125 have mutually different shapes so that a user can distinguish the handle 115 and the handle 125.

### Guide Part

As illustrated in FIG. 9, the left frame 77 has a first guide part 171, a second guide part 172, a third guide part 181, and a fourth guide part 182. The right frame 78 has a first guide part 171, a second guide part 172, a third guide part 181, and a fourth guide part 182. The first guide part 171, the second guide part 172, the third guide part 181, and the fourth guide part 182 of the right frame 78 have shapes respectively symmetrical in the left-right direction to the shapes of the first guide part 171, the second guide part 172, the third guide part 181, and fourth guide part 182 of the left flame 77. In the following description, the first guide part 171, the second guide part 172, the third guide part 181, and the fourth guide part 182 of the left frame 77 will be described. The description of the first guide part 171, the second guide part 172, the third guide part 181, and the fourth guide part 182 of the right frame 78 will be omitted. Note that in FIG. 3 and FIG. 4, the first guide part 171, the second guide part 172, the third guide part 181, and the fourth guide part 182 are omitted from the illustration. A combination of the first guide parts 171 and the second guide parts 172 of the left frame 77 and the right frame 78 is an example of a first holder. A combination of the third guide parts 181 and the fourth guide parts 182 of the left frame 77 and the right frame 78 is an example of a second holder.

The first guide part 171 is a groove recessed to the left from an inner surface 77A of the left frame 77. The first guide part 171 is defined by two first guide surfaces 173, 174 facing each other with a spacing in the front-rear direction, and an end surface 175. The end surface 175 is a plane defining an end in a direction in which the first guide part 171 extends. The first guide part 171 has an opening 176 that opens upward. The first guide surfaces 173, 174 extend generally downward from the opening 176. The protrusion 191L can move in a groove of the first guide part 171 along the first guide surfaces 173, 174.

An upper portion 171U of the first guide part 171 extends downward from the opening 176, while a lower portion 171L of the first guide part 171 extends in a direction crossing a downward direction from a lower end of the upper portion 171U. A direction in which the lower portion 171L extends is inclined from the lower end of the upper portion 171U toward a center in the front-rear direction of the main body 11. The end face 175 is located at an end in the direction in which the lower portion 171L extends. The protrusion 191L is restricted from moving downward and forward by abutting against the end face 175.

The second guide part 172 is a groove recessed to the left from the inner surface 77A of the left frame 77. The second guide part 172 is disposed in rear of the first guide part 171. The second guide part 172 is defined by two second guide surfaces 177, 178 facing each other with a spacing in the front-rear direction. The second guide part 172 has an opening 179 that opens upward. The second guide surfaces 177, 178 extend generally downward from the opening 179. The protrusion 192L can move in a groove of the second guide part 172 along the second guide surfaces 177, 178. A length in the up-down direction of the first guide part 171 is shorter than a length in the up-down direction of the second guide part 172.

An upper portion 172U of the second guide part 172 extends downward from the opening 179, and a lower portion 172L of the second guide part 172 extends in a direction crossing a downward direction from a lower end of the upper portion 172U. A direction in which the lower portion 172L extends is inclined from the lower end of the upper portion 172U toward the center in the front-rear direction of the main body 11. In other words, the lower portion 172L of the second guide part 172 is inclined such that the lower portion 172L shifts from the rear end to the front end in the front-rear direction as the lower portion 172L proceeds downward.

As illustrated in FIG. 9, the left frame 77 has the third guide part 181 configured to guide the protrusion 193L of the second cartridge 124 and the fourth guide part 182 configured to guide the protrusion 194L. Note that the right frame 78 has the third guide part 181 configured to guide the protrusion 193R of the second cartridge 124 and the fourth guide part 182 configured to guide the protrusion 194R. The third guide part 181 and the fourth guide part 182 of the left frame 77 have shapes respectively symmetrical in the left-right direction to shapes of the third guide part 181 and the fourth guide part 182 of the right frame 78. In the following, the third guide part 181 and the fourth guide part 182 of the left frame 77 will be described, and the description of the third guide part 181 and the fourth guide part 182 of the right frame 78 will be omitted.

The third guide part 181 is a groove recessed from the inner surface 77A of the left frame 77 toward the left. The third guide part 181 is defined by two third guide surfaces 183, 184 facing each other with a spacing in the front-rear direction, and an end surface 185. The third guide part 181 has an opening 186 that opens upward. The third guide surfaces 183, 184 extend generally downward from the opening 186. The protrusion 191L is guided by the third guide surfaces 183, 184.

An upper portion 181U of the third guide part 181 extends downward from the opening 186, while a lower portion 181L of the third guide part 181 extends in a direction crossing the downward direction from a lower end of the upper portion 181U. A direction in which the lower portion 181L extends is inclined from the lower end of the upper portion 181U toward the center in the front-rear direction of the main body 11. The end face 185 is located at an end in the direction in which the lower portion 181L extends. The protrusion 193L is restricted from moving downward and rearward by contacting the end face 185.

The fourth guide part 182 is a groove recessed to the left from the inner surface 77A of the left frame 77. The fourth guide part 182 is positioned in front of the third guide part 181. The fourth guide part 182 is defined by two fourth guide surfaces 187, 188 facing each other with a spacing in the front-rear direction. The fourth guide part 182 has an opening 189 that opens upward. The fourth guide surfaces 187, 188 extend downward from the opening 189. A movement direction of the protrusion 194L is guided by the fourth guide surfaces 187, 188.

An upper portion 182U of the fourth guide part 182 extends downward from the opening 189, while a lower portion 182L of the fourth guide part 182 extends in a direction crossing a downward direction from a lower end of the upper portion 182U. A direction in which the lower portion 182L extends is inclined from the lower end of the upper portion 182U toward the center in the front-rear direction of the main body 11. In other words, the lower portion 182L of the fourth guide part 182 is inclined such that the lower portion 182L shifts from the front end to the rear end in the front-rear direction as the lower portion 182L proceeds downward.

Mounting of First Cartridge 114 and Second Cartridge 124

As illustrated in FIG. 5, in a state that the first cartridge 114 is not mounted to the main body 11 and a user holds the handle 115, the second roller 412 is located below a rotational center of the first roll 111. As illustrated in FIG. 7, in a state that the second cartridge 124 is not mounted to the main body 11 and a user holds the handle 125, the movable guide 132 is located below a rotational center of the second roll 121.

As illustrated in FIG. 2 to FIG. 4, and FIG. 9, the opening 17 located at the upper part of the main body 11 has a size that allows both the first cartridge 114 and the second cartridge 124 to pass through the opening 17 simultaneously. Each of the first cartridge 114 and the second cartridge 124 can be mounted to a predetermined position in the main body 11 by passing through the opening 17 being a single opening from an outside of the main body 11. The first roll 111 can be attached to and detached from the accommodating part 116 of the first cartridge 114 in a direction crossing the axis of the first roll 111. The second roll 121 can be attached to and detached from the accommodating part 131 of the second cartridge 124 in a direction crossing the axis of the second roll 121. The first roll 111 and the second roll 121 can be attached to and detached from the main body 11 independently from each other.

The protrusions 191L, 191R of the first cartridge 114 enter the first guide parts 171 through the openings 176 of the first guide parts 171. The protrusions 192L, 192R of the first cartridge 114 enter the second guide parts 172 through the openings 179 of the second guide parts 172. The first cartridge 114 moves downward in the internal space of the main body 11 while being guided by the first guide parts 171 and the second guide parts 172. In a case where the protrusions 191L, 191R come into contact with the end faces 175 of the first guide parts 171, and the protrusions 192L, 192R come into contact with the lower ends of the second guide parts 172, the first cartridge 114 is in a state that the first cartridge 114 is mounted to the main body 11. The position of the first cartridge 114 in this state is a first mounting position. Furthermore, the engagement grooves 143 engage with the shaft of the first roller 411. The lock lever 155 engages with the shaft 154.

As illustrated in FIG. 3 and FIG. 4, in the first cartridge 114 located at the first mounting position, the axis of the first roll 111 extends in the left-right direction. The first roll 111 is accommodated in the first cartridge 114. The second roller 412 is biased by the coil spring 142 to contact the first roller 411. In the first mounting position, the facing direction 20 connecting the axis of the first roller 411 and the axis of the second roller 412 is more inclined toward the center in the front-rear direction of the main body 11 compared to the lower portions 172L of the second guide parts 172.

As illustrated in FIG. 2 to FIG. 4, and FIG. 9, the protrusions 193L, 193R of the second cartridge 124 enter the third guide parts 181 through the openings 186 of the third guide parts 181. The protrusions 194L, 194R enter the fourth guide parts 182 through the openings 189 of the fourth guide parts 182. The second cartridge 124 moves downward in the internal space of the main body 11 while being guided by the third guide parts 181 and the fourth guide parts 182. In a case where the protrusions 193L, 193R come into contact with the end faces 185 of the third guide parts 181, and the protrusions 194L, 194R come into contact with the lower ends of the fourth guide parts 182, the second cartridge 124 is in a state that the second cartridge 124 is mounted to the main body 11. The position of the second cartridge 124 in this state is a second mounting position. Furthermore, the engagement grooves 148 engage with the shaft of the first bonding roller 51. The lock lever 152 engages with the shaft 151.

As illustrated in FIG. 3 and FIG. 4, in the second cartridge 124 located at the second mounting position, the axis of the second roll 121 extends in the left-right direction. The second roll 121 is mounted to the main body 11 in a state that the second roll 121 is accommodated in the second cartridge 124 and in a posture that the axis of the second cartridge 124 extends in the left-right direction. The second bonding roller 52 contacts the first bonding roller 51, biased by the coil spring 147. In the second mounting position, the facing direction 21 connecting the axis of the first bonding roller 51 and the axis of the second bonding roller 52 is more inclined toward the center in the front-rear direction of the main body 11 compared to the lower portions 182L of the fourth guide parts 182.

The first mounting position of the first cartridge 114 and the second mounting position of the second cartridge 124 are separated from each other in the front-rear direction. The lock levers 152, 155 are not located between the axis of the first roll 111 and the axis of the second roll 121 in the front-rear direction.

As illustrated in FIG. 2, in a state that the first roll 111 is mounted, the handle 115 is located between the front wall 250 of the main body 11 and the first shaft 112 in the front-rear direction. Substantially a whole of the handle 115 is located above the opening 17. In a state that the second roll 121 is mounted, the handle 125 is located between the front wall 250 and the second shaft 122 in the front-rear direction. A portion of the handle 125 is located above the opening 17. Note that the handles 115, 125 may have the same shape. At least a portion of the handle(s) 115, 125 may be positioned above the opening 17.

In the mounted state, the second roll 121 is located between the front wall 250 and the first roll 111 in the front-rear direction. The first shaft 112 is located above the second shaft 122 in the up-down direction. A portion of the first roll 111 and a portion of the second roll 121 are located above the opening 17. The cover 12 covers a portion of the first roll 111 located above opening 17 in a state that the first roll 111 is mounted to the main body 11, a portion of the second roll 121 located above the opening 17 in a state that the second roll 121 is mounted to the main body 11, and the opening 17. In a state that two rolls are mounted to the main body 11, the first shaft 112 and the second shaft 122 are located above the recording part 30 and the bonding part 50 in the up-down direction.

The first conveyance route 48 conveys the first sheet 101 drawn out from the first roll 111 mounted to the first mounting position, via a position below the first roll 111 in the up-down direction and a position in rear of the first shaft 112 in the front-rear direction. The second conveyance route 49 conveys the second sheet 102 drawn out from the second roll 121, which is mounted to the second mounting position, via a position below the second roll 121 in the up-down direction and a position in front of the second shaft 122 in the front-rear direction. In a case where the first roll 111 is mounted to the main body 11, the first sheet 101 wound around the first roll 111 is drawn out from a position in front of the first roll 111 in the front-rear direction.

In a standby state in which the laminating apparatus 1 is not performing a laminating process, the cutter carriage 82 of the first cutting part 61 is located at the left end side of the guide rail 81. The second cartridge 124 in the second mounting position is located above the first cutting part 61. In a case where the lever 85 of the cutter carriage 82 is located at the first position, the lever 85 does not contact the second cartridge 124 in the second mounting position.

In a state that the second cartridge 124 is removed from the main body 11, the lever 85 of the cutter carriage 82 is located below the opening 17 of the main body 11. As illustrated in FIG. 3, in a case where the lever 85 is pivoted from the first position to the second position in a state that the second cartridge is removed from the main body 11, the lever 85 is located in a region in the internal space of the main body 11 where the second cartridge 124 mounted to the second mounting position occupies. Thus, if the second cartridge 124 is mounted to the main body 11 in a state that the lever 85 is located at the second position, the second cartridge 124 contacts the lever 85 in the second position, and thus the second cartridge 124 does not reach the second mounting position.

### Laminating Process

In a case where the laminating apparatus 1 receives instructions to perform a laminating process from a user, the laminating apparatus 1 drives the motor for conveyance 207 to rotate the first conveyance rollers 41 and the second conveyance rollers 42, thereby causing the first conveyance rollers 41 and the second conveyance rollers 42 to convey the first sheet 101.

In a state that the first sheet 101 has entered an entrance 48A of the first conveyance route 48, the recording surface 107 of the first sheet 101 faces downward (an example of the other side). In a state that the first sheet 101 travels toward the recording part 30 from the entrance 48A through the curved section 48B, the first sheet 101 is inverted such that a portion upstream in the conveyance direction 19 of a leading edge of the recording surface 107 of the first sheet 101 faces upward (an example of one side). In a state that the first sheet 101 passes through a position facing the nozzle surface 32A of the recording head 32, the recording surface 107 of the first sheet 101 faces upward.

Then, the conveyance of the first sheet 101 is stopped, ink is ejected from the nozzle surface 32A of the recording head 32, and an image is recorded on the recording surface 107 of the first sheet 101.

In a case where the leading edge of the first sheet 101, on which image recording has been performed, reaches the bonding part 50, the motor for bonding 208 is driven to drive the bonding part 50. At a position downstream in the conveyance direction 19 of the recording part 30, the recording surface 107 of the first sheet 101 and the bonding surface 109 of the second sheet 102 are gripped by the bonding part 50 and bonded together. Furthermore, at a position upstream in the conveyance direction of an area in which an image has been recorded, the first cutting part 61 cuts the first sheet 101.

The first sheet 101 and the second sheet 102 bonded to each other are cut by the second cutting part 62 after being conveyed until a cutting position reaches a position below the second cutting part 62 and then discharged from the discharge port 16 as a laminated product 100.

### Effect of the Present Embodiment

According to the embodiment described above, the first cartridge 114, the second cartridge 124, and the cutter unit 83 can be replaced independently from each other via the opening 17 of the main body 11. Furthermore, in a case that the second cartridge 124 is removed from the main body 11, the cutter carriage 82 is located at a position facing the opening 17. Therefore, a user can replace the cutter unit 83 by accessing the cutter carriage 82 through the opening 17 of the main body 11 and pivoting the lever 85 from the first position to the second position.

Because a layout in which a pivotal route of the lever 85 overlaps with a region where the second cartridge 124 mounted to the main body 11 occupies is applied, downsizing of the laminating apparatus 1 is realized. Furthermore, if the lever 85 is located at the second position, the second cartridge 124 contacts the lever 85 in a case where the second cartridge 124 is mounted to the main body 11. Thus, a user can recognize that the lever 85 located at the second position should be moved to the first position.

Because the guide 93 has the recess 95 into which the lever 85 located at the second position enters, the guide 93 and the cutter carriage 82 can be disposed close to each other. Thus, the laminating apparatus 1 can be downsized.

Because the lever 85 located at the first position does not contact the second cartridge 124 located at the second mounting position, an impact caused in a case where the second cartridge 124 is mounted to the main body 11 is not transmitted to the lever 85 located at the first position. Thus, breakage of the lever 85 can be prevented.

Because the cutter carriage 82 enters the opening 77A of the left frame 77 or the opening 78A of the right frame 78 at the left and right ends of the guide rail 81, the laminating apparatus 1 can be downsized in the left-right direction.

### Modifications

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the embodiment described above, the cutter unit 83 is replaced by accessing the cutter carriage 82 located at the standby position. However, in a replacement operation of the cutter unit 83, the cutter carriage 82 may be moved from the standby position to a replacement position.

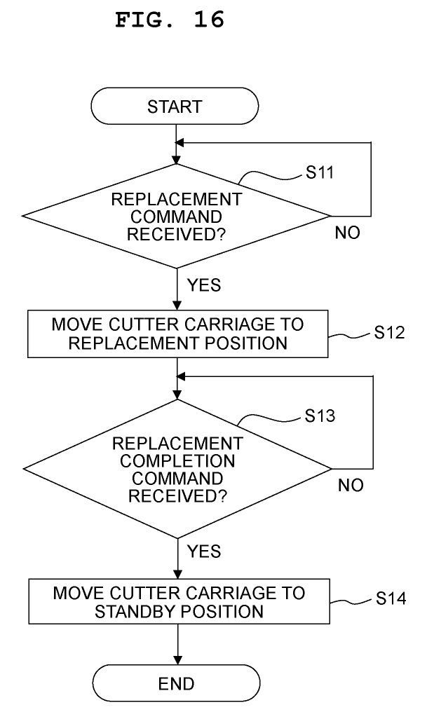

As illustrated in FIG. 16, in a case where the controller 200 receives a replacement command input at the operation part 13 (step S11: YES), the controller 200 drives a cutter motor 210 to move the cutter carriage 82 from the standby position to the replacement position (step S12). The replacement position is, for example, a center in the left-right direction of the guide rail 81, but may be appropriately set between the left frame 77 and the right frame 78. A user opens the cover 12, removes the second cartridge 124 from the main body 11, and then operates the lever 85 of the cutter carriage 82 located at the replacement position to replace the cutter unit 83. Because the cutter carriage 82 is located below the opening 17 of main body 11, access to the cutter unit 83 is easy. Thus, replacement of the cutter unit 83 is easy.

In a case where the controller 200 receives a replacement completion command input at the operation part 13 (step S13: YES), the controller 200 drives the cutter motor 210 to move the cutter carriage 82 from the replacement position to the standby position (step S14), and then terminates the operation. The user then mounts the second cartridge 124 to the main body 11 and closes the cover 12.

The configuration of the first cutting part 61 may be modified from the above described embodiment. For example, the cutter carriage 82 may not have the lever 85. Furthermore, the first cutting part 61 may be configured to include, for example, a movable blade that moves in the up-down direction in response to a driving force from a motor, and a fixed blade facing the movable blade.

In the above embodiment, the second cartridge 124 mounted to the main body 11 and the first cutting part 61 overlap with each other as viewed in the up-down direction. However, the first cutting part 61 may be located such that the first cartridge 114 mounted to the main body 11 and the first cutting part 61 overlap with each other as viewed in the up-down direction.

In the above embodiment, both of the first cartridge 114 and the second cartridge 124 can be attached to and detached from the main body 11. However, a configuration in which one of the first cartridge 114 or the second cartridge 124, which is disposed above the first cutting part 61 or overlaps with the first cutting part 61 as viewed in the up-down direction, can be attached to and detached from the main body 11 is applicable. In this case, the other of the first cartridge 114 or the second cartridge 124 may be fixed to the main body 11.

A recording system of the recording part 30 is not limited to an inkjet system. For example, the recording part 30 may employ a thermal system, in which a recording material is transferred onto the first sheet 101 by heating.

What is claimed is:

1. A recording apparatus comprising: a main body having an opening defined at an upper end of the main body; a cover; first and second holders; a conveyance route; a recording part; a bonding part located downstream of the recording part, in a conveyance direction of the conveyance route; and a cutting part located upstream in the conveyance direction of the bonding part and downstream in the conveyance direction of the recording part, wherein the cover is configured to open and close the opening of the main body; the first holder is configured to hold a first cartridge mounted to the main body, the first cartridge holding a first roll in which a first sheet is wound; and the second holder configured to hold a second cartridge mounted to the main body, the second cartridge holding a second roll in which a second sheet is wound; the conveyance route is configured such that the first sheet travels through the conveyance route in the conveyance direction; the recording part is configured to record an image on the first sheet travelling through the conveyance route; the bonding part is configured to bond the first sheet and the second sheet together; the cutting part is configured to cut the first sheet; a particular cartridge being the first cartridge or the second cartridge is mountable to the main body through the opening of the main body; and the particular cartridge mounted to the main body is located above the cutting part.

2. The recording apparatus according to claim 1, wherein the cutting part and the particular cartridge mounted to the main body overlap with each other as viewed in an up-down direction.

3. The recording apparatus according to claim 1, wherein the cutting part includes: a fixed blade extending in a width direction, the width direction being orthogonal to an up-down direction and the conveyance direction; a carriage configured to move along the fixed blade; and a cutter unit attachable to and detachable from the carriage, and the cutter unit includes: a cutter; and a holder holding the cutter.

4. The recording apparatus according to claim 3, further comprising a controller: wherein the controller is configured to move the carriage from a standby position to a replacement position below the opening of the main body, depending on receiving of a replacement command.

5. The recording apparatus according to claim 4, wherein a distance between the replacement position and a center in the width direction of the opening is smaller than a distance between the standby position and the center in the width direction of the opening.

6. The recording apparatus according to claim 3, wherein the carriage further includes a lever configured to move between a first position at which the lever holds the cutter unit and a second position at which the lever allows the cutter unit to be removed from the carriage, and in a state that the particular cartridge is removed from the main body, the lever is located below the opening of the main body.

7. The recording apparatus according to claim 6, wherein in a state that the particular cartridge is removed from the main body, the lever of the cutter unit in the second position is located in a region, in the main body, occupied by the second cartridge in a case where the particular cartridge is mounted to the main body.

8. The recording apparatus according to claim 6, wherein the main body includes a guide configured to guide the second sheet to the bonding part, and the guide has a recess configured such that the lever located at the second position is entered into the recess.

9. The recording apparatus according to claim 7, wherein the lever located at the first position does not contact the second cartridge mounted to the main body.

10. The recording apparatus according to claim 8, further comprising a gear train including a plurality of gears configured to transmit driving to a shaft of the second roll, wherein the gear train is located at a first end side in a direction in which the carriage moves, and the recess is located at a second end side, opposite to the first end side, in the direction in which the carriage moves.

11. The recording apparatus according to claim 3, wherein the main body includes a frame, and the frame has an opening configured such that the carriage enters into the opening.

12. The recording apparatus according to claim 1 wherein the particular cartridge is the second cartridge.
